(19) United States
(12) Patent Application Publication
(10) Pub. No.: US 2009/0207771 A1
(43) Pub. Date: Aug. 20, 2009

(54) Broadcast AMD Multicast On High Speed Downlink Channels

(75) Inventors: Jan Lindskog, Pixbo (SE); Anders Ranheim, Goteborg (SE)

Correspondence Address: ERICSSON INC., 6300 LEGACY DRIVE, M/S EVR 1-C-11, PLANO, TX, 75024, US

(73) Assignee: TELEFONAKTIEBOLAGET L M ERICSSON (PUBL), Stockholm (SE)

(21) Appl. No.: 12/307,533

(22) PCT Filed: Jul. 4, 2006
(86) PCT No.: PCT/IB2006/052236

§ 371 Date: Jan. 5, 2009

(51) Int. Cl. H04H 20/71

(52) U.S. Cl. 370/312

(57) ABSTRACT

A high speed downlink packet access base station (HSPDA Node B) and a method therefore working in acknowledged mode (AM), the base station being adapted for unicast transmission on a physical downlink shared channel (HS-DSCH), by preceding announcement on a shared control channel (HS-SCCH) which shared control channel may be decoded by a given user entity using its own identity (UE-ID), each user entity (UE) being adapted for transmitting an acknowledge (ACK) or non-acknowledge (NACK) message pertaining to the reception of the given transmission on an uplink dedicated physical control channel (HS-DPCCH) pertaining to a given HARQ process of a given individual user entity. The base station is performing multicast transmissions (11, 401) on the physical downlink shared channel (HS-DSCH) by preceding announcement on the shared control channel (HS-SCCH) coded with a multicast identity (MU-ID) of a reserved address space, which downlink shared channel (HS-SCCH) may be decoded simultaneously by a plurality of user entities, wherein each user entity is using the multicast identity (MU-ID) instead of the user entity's respective user identity. A user entity and a method therefore have moreover been provided.

### FIELD OF THE INVENTION

The present invention relates to methods for HSDPA for downlink broadcast and multicast services such as transmission of TV channels to mobile handsets.

### BACKGROUND OF THE INVENTION

Digital terrestrial TV, DVB-H (Digital Video Broadcast—Handheld) is one solution for TV in mobile handsets based on and being largely compatible with the digital terrestrial television broadcasting standard DVB-T. DVB-H is performed by means of the DVB-T standard employing OFDM multi carrier modulation. Extended DVB-H parameter signaling is added above the DVB-T protocol layer, such that DVB-H services can be transmitted via DVB-T networks. The added features concern time slicing and enhanced forward error correction, easing the power consumption of hand held devices and improving reception in poor signal conditions, respectively.

Downlink transmission of TV channels can be envisaged in various ways. One option is to integrate terrestrial TV receivers in mobile hand-held units. Another alternative is to initially download media clip to the mobile unit and subsequently play the content.

Multicast and broadcast features have been standardized in the MBMS (Multimedia Broadcast Multicast Service) defined in 3GPP 22.146 (Stage 1), 23.146/25.346/43.246 (stage 2) and various stage 3 specifications. In specification 3GPP 25.346 point to multi-point transmission (multicast) are performed over the FACH (Forward Access Channel) channel, while point to point messages (unicast) are handled over the DTCH (Dedicated Traffic Channel) and DCCH (Dedicated Control Channel) channels. Moreover, the so-called unacknowledged mode is used, which does not provide for re-transmissions.

The known high speed downlink packet access (HSDPA) service can provide transmissions of streaming content to a plurality of users by means of unicast distribution. However, HSDPA is not targeted for multicast/broadcast distribution which is required for efficient bandwidth utilization. This may be acceptable when customers prefer to download video clip before playing the content, but when multiple users are simultaneously watching the same video stream, such a solution is very bandwidth consuming.

### HSDPA:

As the name implies, the High Speed Downlink Packet Access (HSDPA) technology introduced in 3GPP provides substantial data capacity advantages. The technical specification 3GPP TS 25.321 concerns the MAC (Media Access Control) architecture and the various entities form a functional point of view. 3GPP 25.211 basically describes how information from the MAC-layers is mapped onto the channels sent out on the air.

In contrast with release 99 which exclusively defines channels between the RNC and the UE, HSPDA defines a HS-PDSCH (High-Speed Physical Downlink Shared Channel) channel which is terminated between the user entity and the base station set (BSS) also denoted Node B. The HSPDA Medium Access Control (MAC-hs) enables increased packet data throughput due to link adaptation (Adaptive Modulation Coding—i.e. 16QAM or QPSK) and fast physical layer retransmission and combining. Hence, besides incorporating the WCDMA access technology, Node B carries out scheduling and Hybrid Automatic Repeat Request (H-ARQ) retransmissions on the channel between the user entity and Node B. The benefits and the features of the above system have for instance been described in “WCDMA evolved—High Speed packet data services”, by Stefan Parkwall et al., Ericsson review No. 2, 2003.

FIG. 1 shows the major channels and key timing properties utilized in HSPDA, see also 3PPP 25.211 specification chapter 7. The HSPDA transmission makes use of a 2 ms transmission time interval (three time slots).

On the downlink side there is provided: Several common data channels 1, a Downlink Physical Channel (DPCH-R99) 2 for each user entity using HSPDA transmissions; a common High Speed Shared Control Channel (HS-SCCH) for control signaling 3, a number of High Speed—Physical Downlink Shared Channels (HS-PDSCH) user data channels 4-5, which are allocated HSPDA data in a flexible manner.

On the uplink side there is provided: a High Speed—Dedicated Physical Control Channel (HS-PDCCH) 6—for, among other things, providing channel quality information, CQI, and HSPDA automatic request signaling—and an uplink dedicated channel associated with each HSPDA user comprising control information and data, 7.

HSDPA (High Speed Downlink Packet Access) facilitates high speed transmission on the downlink from Node-B and to the user entity (UE). Under HSPDA, Node-B buffers incoming downlink end-user data and utilizes an internal scheduling entity to determine on which particular channel and when to transmit buffered data according to a scheduling routine. To aim in the scheduling decision, Node-B continuously receives channel quality estimates from the UE entities. Node-B also has knowledge about UE receive capabilities.

Node-B can transmit MAC-hs PDUs (Media Access Control High Speed Protocol Data Units) to the UEs at a pace of up to 500 times per second. At each 2 ms transmit opportunity (TTI transmit time interval) Node-B can vary the MAC-hs PDU size depending on the buffered amount of data, the channel quality estimates, the UE capabilities and the granted amount of downlink codes available. MAC-hs data for 1 UE up to 4 UEs can be scheduled at each 2 ms transmit opportunity utilizing code division (WCDMA) among the scheduled UEs.

The UE decodes the HS-SCCH (High Speed Shared Control Channel), and upon a successful CRC checksum, the UE continues to decode the HS-PDSCH (High Speed Physical Data Shared Channel). Depending on the outcome of the HS-SCCH and HS-PDSCH, the UE transmits a reception feedback back to the peer Node-B.

The reception feedback is interpreted by the Node-B transmitter, which upon a negative feedback indicating a possible reception failure for the UE, retransmits data.

According to specification 3GPP 25.321 chapters 11.6.1 and 11.6.2, a HSPDA N-channel stop and wait (SAW) ARQ is utilized, implying that a number of 1-8 HARQ processes may exist at a time per user entity. The timing relation between the downlink HS-DPCCH channel and the uplink ACK/NACK transmissions on the HS-PDSCH are fixed, that is, the ACK, NACK messages are arranged to be transmitted, such that there are always 7, 4-7, 6 TTI slots between a transmission and the associated expected ACK/NACK from a user entity. This allows for Node-B to easily determine when to retransmit data in the case of a missing response to a first transmission. Having multiple ARQ processes is a way to secure high channel utilization. Had only one HARQ process been available, the particular response—associated with the round trip time—from one particular user had to be awaited before a subsequent protocol data unit could be transmitted, leading to inefficient channel utilization. The 8 HARQ processes mentioned above corresponds to the number of downlink transmissions to a given entity which can be accomplished before the NACK/ACK pertaining to the first downlink transmission is received at the base station.

### HSDPA Data Addressing:

A user identity (UE ID) that identifies the UE for which the HS-SCCH information is intended is implicitly included in the CRC (Cyclic Redundancy Check). When generating the CRC checksum in Node-B, the user identity (UE ID) is included in the calculation. Upon reception of a HS-SCCH, a UE utilizes its ID in the calculation of the CRC to check whether HSDPA data is destined to the UE in question.

In FIG. 3′ the coding properties have been shown in more detail and in FIG. 3″ the user entity decoding the HS-SCCH has been indicated. In spec. 3GPP 25.212 the mandatory principles for coding has been explained in more detail.

### HSDPA in Uplink:

The uplink (from UE to Node-B) is used to signal the acknowledgement conveying the reception status (as described above) and information regarding the instantaneous radio channel conditions.

An additional uplink channel, denoted HS-DPCCH, is used for that purpose and is code multiplexed with the current DPDCH/DPCCH.

### Exception Handling in UE:

To recover from the situation where the transmitter in Node-B has discarded a MAC-hs PDU (protocol data unit), the UE receiver utilizes two mechanisms to solve the problem (see 3GPP.321 chapter 11.6.2.3 for exact details):

### Timer Based Stall Avoidance:

The receiver keeps track of the next PDU (MAC-hs) to be received by analyzing the PDU sequence number sent in HS-DSCH. Whenever the received sequence number differs from the next expected, a timer (T1) is started. Until the timer T1 expires, the ARQ protocol will retransmit to resolve the situation. When the timer expires, the receiver updates it's next expected sequence number to allow for proceeding data to be received.

### Window Based Stall Avoidance:

A receiver window is defined. Upon the reception of MAC-hs PDU with sequence number above (or outside) the receiver window the receiver will shift it's receive window to allow for preceding PDU's to be successfully accepted by the receiver.

According to the known standard (Rel. 6), in each 2 ms interval corresponding to one HS-DSCH TTI, one HS-SCCH carries physical layer signaling to a single UE. Up to four HS-SCCH as seen from a UE point of view, i.e. the UE must be able to decode up to four HS-SCCH in parallel.

The following information is carried on the HS-SCCH:
transport format and resource related information (TFRI), consisting of
   HS-DSCH channelization-code set (7 bits)—part 1
   HS-DSCH modulation scheme (QPSK/16QAM) (1 bit)—part 1
   HS-DSCH transport block size (6 bits)—part 2
Hybrid—ARQ related information, comprising—part 2
   HARQ process number (3 bits)—part 2
   redundancy number (3 bits)—part 2
   New data indicator (1 bit)—part 2
User entity identity (UE ID)—10 bits) for which the HS-SCCH information is intended (10 bits)—coded into part 1+2?

The user entity uses its own user identity to detect
if it is the intended receiver of the decoded HS-SCCH information
detect if there are errors in the decoded HS-SCCH information, which will result in a DTX (Discontinuous Transmission) in the uplink HS-PDCCH channel.

A user identity (UE ID) (RNTI, Radio Network Temporary Identifier) that identifies the UE for which the HS-SCCH information is intended to is used as a scrambling code of the HS-SCCH. When coding the HS-SCCH in Node-B, the user identity (UE ID) is included using a CRC mechanism. The details are given in 3GPP 25.212. Upon reception of a HS-SCCH, a given UE utilizes its ID to descramble the HS-SCCH to check whether HSDPA data is destined to the UE, i.e. if the HS-SCCH is successfully decoded. The HS-SCCH contains Transport-Format and Resource-related-Information (TFRI) and HARQ related information such as HARQ process number, redundancy version and a New-Data-Indicator (NDI).

### Uplink Signaling:

The up-link HS-DSCH related physical layer signaling on the HS-PDCCH consists of
Acknowledgement for HARQ
Information (channel quality information—CQI) relating to instantaneous downlink radio channels to assist Node B in fast link adaptation and scheduling,

The HARQ acknowledgement consists of a single information bit which is interpreted in the following way:

+1: data in HS-DSCH TTI correct, positive ACK
−1: data in HS-DSCH TTI not correctly decoded, NACK.
DTX (Discontinuous Transmission): No HS-DSCH data received, HS-SCCH not correctly decoded.

Each UE has its own unique scrambling code and Node B receives data continuously, depending on for example channel conditions. When a HARQ process transmits data, Node B will receive acknowledgement from the destined UE by descrambling the UEs scrambling code.

### SUMMARY OF THE INVENTION

It is a first objective of the invention to set forth a method for providing bandwidth efficient streaming of downlink data over the HSPDA transmission protocol.

This object has been achieved by a high speed downlink packet access base station (HSPDA Node B) working in acknowledged mode (AM), the base station being adapted for unicast transmission on a physical downlink shared channel (HS-DSCH), by preceding announcement on a shared control channel (HS-SCCH) which shared control channel may be decoded by a given user entity using its own identity (UE-ID), each user entity (UE) being adapted for transmitting an acknowledge (ACK) or non-acknowledge (NACK) message pertaining to the reception of the given transmission on an uplink dedicated physical control channel (HS-DPCCH) pertaining to a given HARQ process of a given individual user entity. The base station is performing multicast transmissions (11, 401) on the physical downlink shared channel (HS-DSCH) by preceding announcement on the shared control channel (HS-SCCH) coded with a multicast identity (MU-ID) of a reserved address space, which downlink shared channel (HS-SCCH) may be decoded simultaneously by a plurality of user entities, wherein each user entity is using the multicast identity (MU-ID) instead of the user entity's respective user identity.

This object has moreover been achieved by a user entity working in acknowledged mode (AM), the user entity being adapted for receiving unicast transmission on a physical downlink shared channel (HS-DSCH), by preceding announcement on a shared control channel (HS-SCCH) which shared control channel may be decoded by the user entity, using its own identity (UE-ID), the user entity (UE) being adapted for transmitting an acknowledge (ACK) or non-acknowledge (NACK) message pertaining to the reception of the given transmission on an uplink dedicated physical control channel (HS-DPCCH) pertaining to a given HARQ process of a given individual user entity.

The user entity is
receiving multicast transmissions (11, 401) on the physical downlink shared channel (HS-DSCH) by preceding announcement on the shared control channel (HS-SCCH) coded with a multicast identity (MU-ID) of a reserved address space, which downlink shared channel (HS-SCCH) may be decoded simultaneously by a plurality of user entities, wherein each user entity is using the multicast identity (MU-ID) instead of the user entity's respective user identity.

The user entity method according to a preferred embodiment comprises the steps of
testing (202) whether a shared control channel (HS-SCCH) is successfully decoded with the given user entity identity (UE ID),
testing (203) whether the shared control channel (HS-SCCH) is successfully decoded with a multicast identity (MU ID),
if the shared control channel is successfully decoded with at least a multicast or a user entity identity (202; 203) and—if a given HARQ process is successfully decoded (205),—generating an acknowledge message (ACK), and if not, generating a not acknowledge message (NACK).

The above object has moreover been accomplished by a user entity is performing channel selection according to a method comprising the steps of
browsing the web and activating a multicast user entity identity (301),
receiving a pre-configuration comprising a list of multicast identities (MU ID) corresponding to respective channels of various content (302),
selecting a given multicast identity (MU ID) and subsequently using the selected multicast identity (MU ID) in decoding of the downlink shared control channel (HS-SCCH) (302, 203).

According to a further advantageous embodiment, bandwidth is economically dealt with by, the respective feedback channel from each respective UE is not used by the Node-B. Instead, according to a first variant, Node-B carries out a repetition scheme of protocol data units to assure a satisfactory reception of data at the receiver side. According to a second variant, the repetition scheme may vary dynamically with estimated channel information (CQI) received from user entities making use of the multicast transmission, such that the number of repetitions depends on the estimated channel quality.

Further advantages will appear from the following detailed description of the invention.

### BRIEF DESCRIPTION OF THE DRAWINGS

FIG. 1 shows an excerpt of prior art HSPDA down-link and up-link channels,

FIG. 2 shows a base station (Node B) according to all embodiments of the invention,

FIG. 3 shows a user entity of as first embodiment of the invention,

FIG. 4 shows medium access control messages (MAC) between a base station and multiple user entities according to the first embodiment of the invention,

FIG. 5 shows a method relating to the base station of the first embodiment of the invention,

FIG. 6 shows another method relating to the user entity of the first embodiment of the invention,

FIG. 7 shows a multicast channel selection performed in various embodiments of the user entity according to the invention,

FIG. 8 shows another method relating to a base station of a third embodiment of the invention,

FIG. 9 shows first repetition scheme according to the invention,

FIG. 10 shows a second repetition scheme according to the invention,

FIG. 11 shows a third repetition scheme according to the invention, and

FIG. 12 shows a fourth repetition scheme according to the invention.

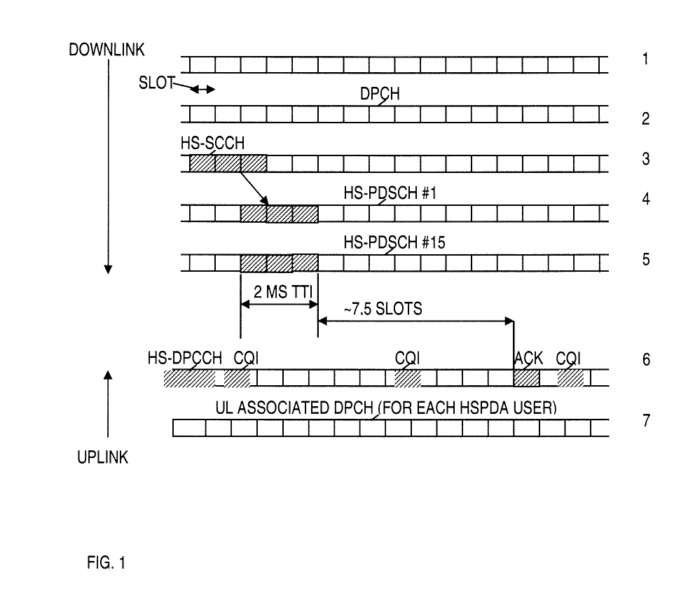

### DETAILED DESCRIPTION OF PREFERRED EMBODIMENTS OF THE INVENTION

### Embodiment 1

According to the invention, multicasting is introduced on the HSPDA radio access interface between the base station set and multiple user entities wherein, a particular multicast HSDPA UE address is introduced in parallel to the normal unicast address, for transmitting content to multiple users in at least one cell simultaneously.

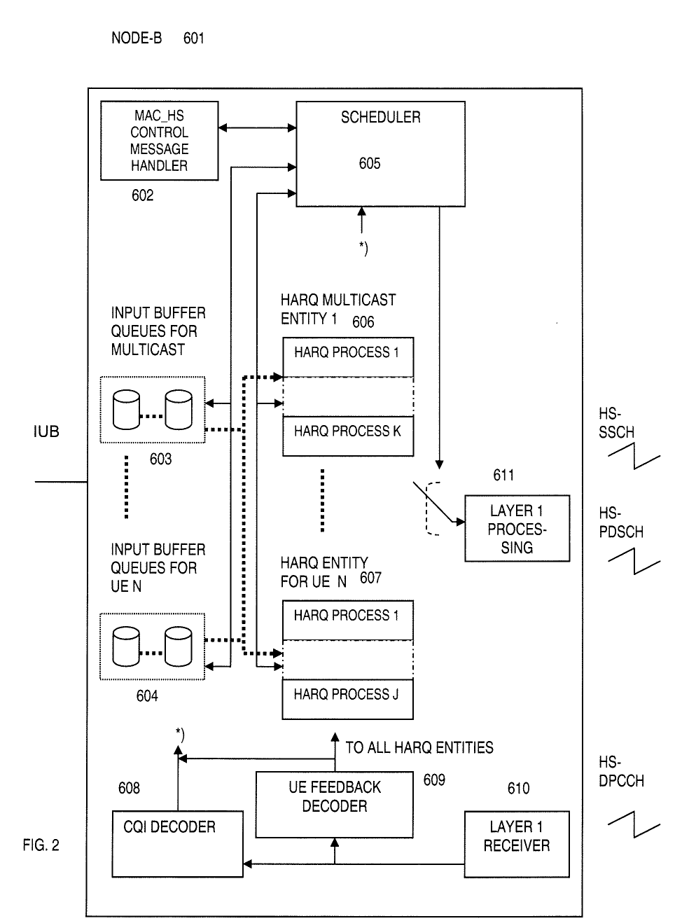

In FIG. 2, a base station (Node B) according to all embodiments of the invention are shown.

The base station (node B) 601 comprises a MAC-hs control message handler 602, a scheduler 605, a number of input buffers 604 storing segments of data streams pertaining to individual user entities, UE1-UEn, corresponding to a number 1-J of HARQ processes 607 for handling simultaneous transmissions to several UE's, that is, for each user entity as well, Layer 1 processing means 611 for transferring data from respective HARQ processes. The base station moreover comprises a CQI decoder 608, a user entity (UE) feedback decoder 609 and a layer 1 receiver 610.

Each HARQ process in a given user entity is mirrored in Node B, and corresponds to a given data stream which is received by a particular user entity. As explained above, more data streams may be consumed by the user simultaneously corresponding to one application or more simultaneous applications running on the user entity apparatus, possibly with different QoS requirements.

Moreover, Node B comprises at least one specific input buffer queue 603 dedicated to multicast content and a corresponding set of HARQ processes in a multicast HARQ entity 606 dedicated to the multicast content. In this context, it should be noted that the term multicast content shall be used to also cover a broadcast distribution as is known from radio or television distribution/Internet broadcast addresses, that is, when more users in a cell receive protocol data units from one particular stream of protocol data units in at least one radio cell to which node B is connected via appropriate base station transceivers.

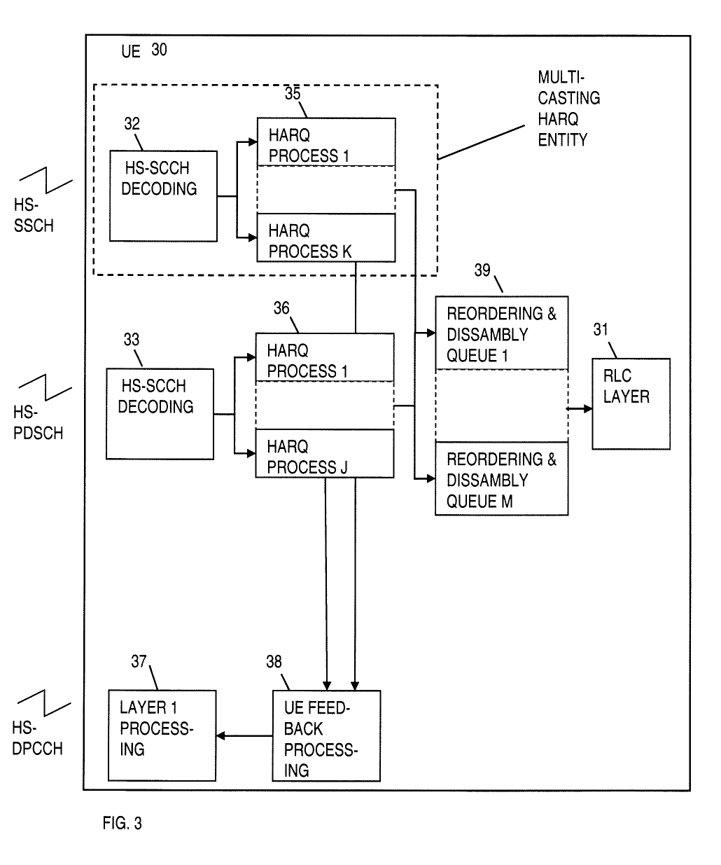

In FIG. 3, a user entity (MAC) arrangement 30 according to the first, third and fourth embodiment of the invention is shown comprising HS-SCCH decoding means 33, for decoding the downlink HD-PDSCH channel, arrangements consisting of a number J HARQ processes 36, a number M of reordering and disassembly queues 39 and a RLC (Radio Link Control) layer means 31. Moreover, there is provided UE (User Entity) feedback processing means 38 and layer 1 processing 37 for providing feed-back on the HS-DPCCH channel.

The reordering queue distribution function 39 routes the MAC-hs PDU's to the correct reordering buffer based on a Queue ID. The reordering entity 39 reorders received MAC-hs PDU's according to the received TSN (transmit sequence number. MAC-hs PDUs with ascending TSN's (MAC-hs Transmit Sequence Numbers) are delivered to the disassembly function. To recover from erroneous conditions when MAC-hs PDU's are missing, the same avoidance handling as described in 3GPP TS 25.321-11.6.2, re-ordering release timer and window based stall avoidance mechanisms are used. There is one reordering entity for each Queue ID configured at the UE. The disassembly entity 39? is responsible for the disassembly of MAC-hs PDU's. When a MAC-hs header is removed, the MAC-d PDU's are extracted and any padding bits are removed. Then the MAC-d PDUs are delivered to the higher (RLC) layer. These features have been described in 3GPP TS 25.321-11.6.2.3.

The user entity (UE) 30 adapted to receive the multicast content according to the invention moreover comprises at least one dedicated HS-SSCH multicast channel decoder 32 and a corresponding set of HARQ process entities 35 mirroring the multicast content HARQ processes of Node B. The received data from the HARQ entities are conveyed to the re-ordering and disassembly queues 39 and transported to the upper RLC layer in the appropriate increasing sequence order.

Apart from descrambling the CRC (cyclic redundancy check) with the user identity (UE ID), the UE also descrambles the CRC with the previously received multicast ID and upon successful result receives the HSDPA multicast data.

The base station according to the invention transmits multicast data in a similar way as for the known unicast transmissions. However, a specific multicast address here denoted multicast ID within a group of specific multicast addresses reserved for the user entities receiving the multicast data, is used. The format of the multicast address is not different from an ordinary user entity address; it is the particular predetermined allocation of a predetermined address field devoted to multicast transmission which characterizes the multicast identities.

According to the first embodiment of the invention, when transmitting multicast data to several UEs, each UE transmits a response exactly as for ordinary unicast HSDPA data—using its own scrambling code. Consequently, Node B can not transmit unicast HSDPA data simultaneously in the very same TTI—since only one feedback per TTI is provided—since there is only 1 scrambling code per UE—or only 1 channel specified. However, in practice since the TTI is 2 ms, ordinary data can be transmitted interleaved with multicast if the UE supports “simultaneous” unicast/multicast HSDPA transmissions.

According to the invention, the user entity can be informed of specific multicast content, such as streaming services, on a web page, whereby the given content would be transferred to the user entity on choosing a given URL, as commonly known in the art. When an end user requests to join an ongoing video stream, the HSPDA enabled UE may receive a given predetermined multicast HSDPA UE address, by for instance a browsing session such is generally known from the web with regard to streaming services, i.e. the user enters a URL corresponding to the address on a streaming server which simultaneously causes the opening of a predetermined media application, such as the MS Media Player™ or REAL™ player.

When Node B transmits a multicast protocol data unit on the multicast/broadcast address, multiple UE's may experience a successful reception of the HS_SCCH control channel and decode the HS_DSCH data channel.

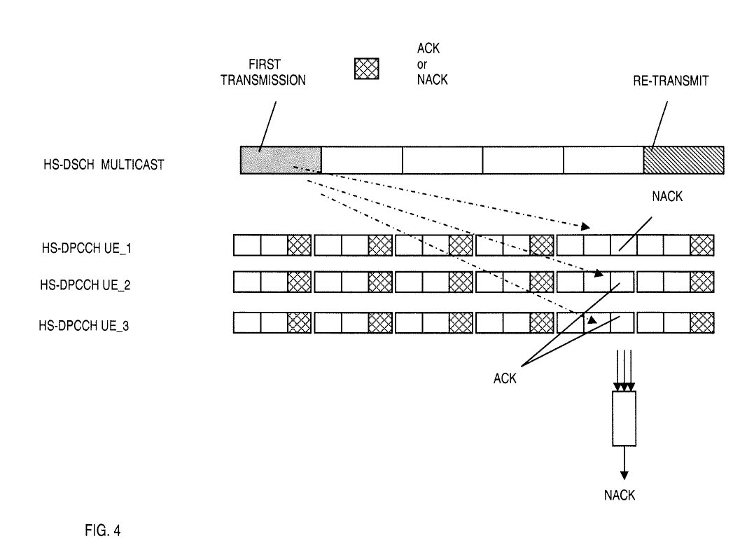

This has been shown in FIG. 4, whereby a first multicast content protocol data unit trans-mission is scheduled on the HS-DSCH channel. A fixed number of TTI's later the corresponding feedback for the transmitted first transmission can be expected on respective HS-DPCCH channels. User entities UE's that successfully decoded the downlink HS-SCCH multicast addressed transmission will reply with an Acknowledge message comprising the given user entity's identity, while those user entities that would receive an erroneous CRC calculation will respond with an not-acknowledged signal, thereby prompting Node B to re-transmit the erroneously received transmission.

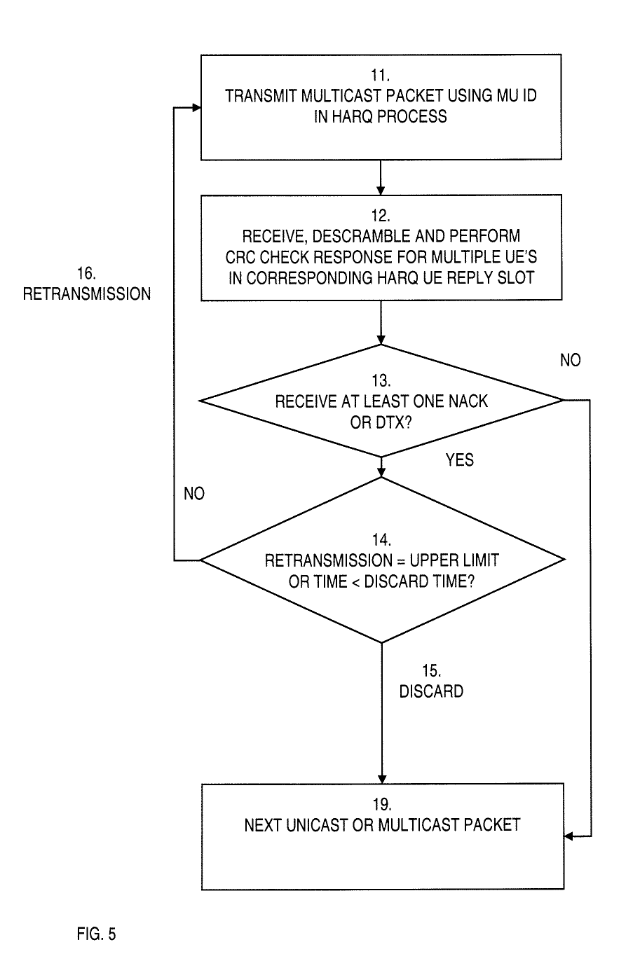

Node-B distinguishes whether the feedback from a specific UE corresponds to a unicast transmission or was part of the at least one multicast transmission. As illustrated in FIG. 4, Upon a multicast transmission, Node-B investigates feedback from all UEs in the multicast/broadcast group. Assume a multicast transmission occurred to a group of three UE, denoted UE_1, UE_2 and UE_3. Assume further that UE_1 and UE_2 successfully received the HS-DSCH whilst UE_3 failed to receive HS-DSCH. Node B performs a resolving process, see also step 13, FIG. 5 later, whereby if at least one NACK (or DTX) is received, Node B will re-transmit the previous signal if accepted by the retransmit procedures in the Node B. If the resolving operation results in an ACK, Node-B proceeds as for the unicast transmission, that is, it proceeds with subsequent protocol data units.

To avoid excessive retransmissions of multicast transmissions—which could appear if e.g. one UE has very poor reception quality, or when the total transmission time exceeds a certain threshold—Node B utilizes a multicast re-transmission procedure. Such a procedure may be based on a maximum number of retransmissions or based on a trans-mission time from first transmission until last retransmission or a combination thereof. When exceeding these restrictions Node B will discard the ongoing multicast transmission, see also step 14 in FIG. 5.

Upon the exceptional event, when one or more of the multicast/broadcast UEs fails to receive data despite retransmissions, Node-B proceeds as for unicast data, i.e. Node B discards data and continues transmission of subsequent data. The UE utilizes the same “exceptional” procedure as for unicast reception to deal with this situation.

The exemplary procedure carried out in node B has been shown in more detail in FIG. 5

In step 11, the base station is performing multicast transmissions (11, 401) on the physical downlink shared channel (HS-DSCH) by preceding announcement on the shared control channel (HS-SCCH) coded with a multicast identity (MU-ID) of a reserved address space, which downlink shared channel (HS-SCCH) may be decoded simultaneously by a plurality of user entities, wherein each user entity is using the multicast identity (MU-ID) instead of the user entity's respective user identity, which is used when decoding unicast transmissions.

In step 12, the base station is—receiving and descrambling feedback messages (ACK, NACK, DTX) from a plurality of user entities listening to the given multicast address (M-ID).

In step 13—it is checked whether Node B is receiving at least one not acknowledge message (NACK) or upon receiving at least one discontinuous transmission message (DTX). If no—step 19—the next multicast packet is continued with.

According to step 14 and 16, the at least one HSPDA downlink multicast protocol data units is retransmitted, unless re-transmissions have been attempted above an upper limit or upper time limit, 14, by proceeding in step 11.

If the time limit is exceeded or the number of retransmissions exceeds a time limit, the packet is discarded, step 15.

According to the invention there are several ways for the UE decoding the HS-SCCH channel with the multicast identity (MU ID).

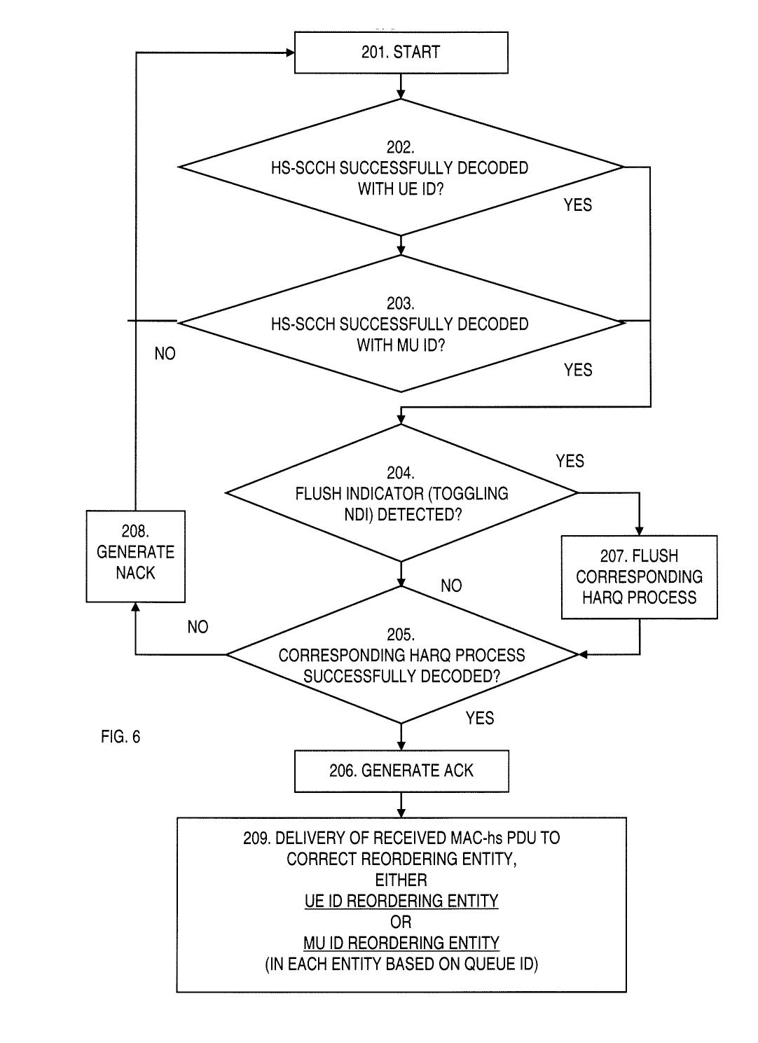

In FIG. 6 the procedure carried out in the user entity of the first embodiment is shown.

In step 201, the procedure starts.

In step 202—it is tested whether a shared control channel (HS-SCCH) is successfully decoded with the given user entity identity (UE ID), if yes proceed to 204, if no, proceed to 203.

In step 203 it is tested whether the shared control channel (HS-SCCH) is successfully decoded with a multicast identity (MU ID),
if the shared control channel is successfully decoded with at least a multicast or a user entity identity, 202; 203, it proceeds to step 204, if not to 201.
   in 204, if a flush indicator (Toggling NDI) is detected, it proceeds to 207 and flushes the corresponding HARQ process, thereafter it proceeds to 205,
if a given HARQ process is successfully decoded, 205,—an acknowledge message (ACK) 206 is generated, otherwise a not acknowledge message (NACK), 208, is generated.

In step 209, when an acknowledge (ACK) signal is generated and the shared control channel (HS-SCCH) was successfully decoded with given user entity identity (UE ID), delivering the MAC-hs protocol data unit to a user identity (UE ID) reordering entity or multicast identity (MU ID) reordering entity in the user entity (UE), based on a given queue identity.

According to the first embodiment of the invention, a media center (Not shown) is used, in which a registration of which user entities consumes multicast content is performed.

The media center interacts with the Multicast sever, distributing the multicast content.

The media center provides information to each Node B, from which user entities a DTX message may be expected.

Consequently, Node-B maps the given information like:

MU_ID=1 contains UE_IDs 44, 56, 63 consume MU_ID 1
MU_ID=2 contains UE_ID 3, 5 consume MU_ID2

### Etc.

The actual signaling for achieving the above mapping can be accomplished in various ways. One option is that the media center sends information to Node-B when the user (UE user) signs up for consuming a given multicast stream, e.g. presses the button for a “channel Ch 4”, on a web page associated with the multicast server.

According to the invention, the user entity is informed about given available multicast identities in the following exemplary way in order to set up the service:

Imagine that an operator transmits 5 channels continuously in its network, Ch1-Ch5 (MU_ID1-MU_ID5). The HSDPA user ID space (or more correct RNTI—Radio Network Temporary Id) that exists is split from [rnti_min . . . rnti_max] to [rnti_min . . . mulicast_max, multicast_max+1 . . . rnti_max]. This means that [rnti_min . . . mulicast_max] is reserved and may NOT be in use for unicast HSDPA. The operator configures every Node B in an area with the following (simplified):

rnti_min: Ch_1 (MU_ID1)
rnti_min+1: Ch_2 (MU_ID2)
and so forth for Ch3-Ch_5 (MU_ID3-5).

The operator transmits the above 5 channels to all Node-B's, which continuously transmit these 5 channels over the air on condition that at least one HSDPA user is setup.

Via a webpage activation or automatic activation, the subscriber gets its UE browser preconfigured with the MU_ID mapping shown above. The user may select Ch_1-Ch_5 and join the desired multicast session.

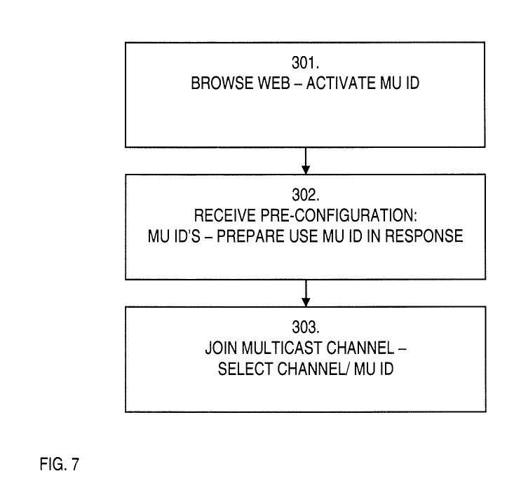

In FIG. 7, the procedure for multicast selection and set-up in a user entity is shown.

The method comprises the steps of the user entity is
browsing the web and activating a multicast user entity identity, 301,
receiving a pre-configuration comprising a list of multicast identities (MU ID) corresponding to respective channels of various content, 302,
selecting a given multicast identity (MU ID) and subsequently using the selected multicast identity (MU ID) in decoding of the downlink shared control channel (HS-SCCH) 302, 203.

According to a further embodiment, bandwidth is saved by not transmitting multicast content from the base station unless at least one UE has requested it. According to this embodiment, Node-B transmits only when receiving a stream from network. The UE equipment transmits an activation request signal to a media distribution centre (not shown) to register—indicating Ch_2, as choice for reception—and given a response on what MU_ID to use.

A further alternative for set-up is using the MBMS specification whereby support of HSDPA is added. This is accomplished by transmitting information on what channels Node-B supports under HSDPA to a MBMS media center—and also transmitting information from the UE on which particular Node B, the user entity resides on. Subsequently, the MBMS transmits channel information and set-up to UE, such that the user entity may use the HSDPA MU_ID.

### First Embodiment

### Alternative

An alternative procedure for the multicast HARQ process in Node B may be carried out basically as shown in FIG. 5. However, according to this embodiment, Node B does not perform any MU_ID-UE_ID mapping.

In a typical network the working point of operation may approximately be

### 90%—ACK

### 9%—NACK

### 1%—DTX

It is observed, that it is more likely to receive a NACK than a DTX. According to this alternative embodiment DTX—indicated in box 13—is not used for determining whether a retransmission should be carried out.

In a given exemplary situation, Node-B does not need to know that UE_ID 44, 56, 63 are members of MU_ID=1. If for instance a transmission to MU_ID=1 occurs—then UE_ID 44 and 56 may transmit ACK whilst UE_ID 63 sends a NACK—Node-B will receive 2 ACK and 1 NACK and thereby assume that there was only 3 members of MU_ID=1 and retransmit. If on the other hand it receives 2 ACK and one DTX—it will assume that all user entities in MU_ID received the message. That is of course wrong since 1 of 3 didn't hear the message. This drawback results in that the third UE fails to receive this MAC-hs PDU and will experience a higher PDU error rate on its application layer. However, this may be accepted since the probability for DTX is low compared to NACK and it allows for a less complex network solution.

### Embodiment 2

In the second embodiment of the invention, the same base station configuration is used as in the first embodiment of the invention.

In the user entity according to the second embodiment of the invention, instead of descrambling the CRC with several ID's—that is, various multicast identities and the unicast user identity in question—only one ID is used for a period of time. Suitably, only one HS_SCCH receiver is provided in the user entity. When multicast content is chosen, a switch is made to the multicast identity, MU ID, in the user identity UE ID for decoding the HS-SCCH channel; otherwise the user identity is used for decoding the HS-SCCH channel. Hence, the user entity design is comparable to a prior art user entity design except for the ability to switch ID for decoding either normal HSDPA downlink unicast data or one multicast reception group at a time.

The user entity acts as shown in FIG. 6, with the exception that only 202 or only 203 are used. Step 203 is used if multicast reception is activated thus deactivating unicast reception in step 202, and vice versa using step 202 only when multicast reception is deactivated (step 203 omitted).

Node B operation is as in FIG. 5. It can be observed that Node B must be informed about the mode of operation for the UE, that is, whether the user entity consumes multicast or unicast transmissions. The MU_ID-UE_ID mapping discussed above can be used for this purpose. This is needed in order to distinguish whether a DTX is due to a failure to receive multicast MAC-hs PDU, or whether it is due to that the UE receiver has switched over to receive unicast MAC-hs traffic.

It can also be observed that for the ‘First embodiment—alternative’ the mode of operation at the UE is not needed in Node B. This is due to the fact that DTX is not considered at the Node-B.

Hence, this embodiment provides a cost effective UE receiver design where the UE can receive both unicast HSDPA data and HSDPA multicast/broadcast data.

### Embodiment 3

According to a third embodiment of the invention, the respective feedback channel from each respective UE is not used by the Node-B. The user entities may transmit feedback as in embodiment 1 and 2, but the feedback is not utilized by Node-B when a multicast transmission has occurred.

Instead, according to a first variant, Node-B carries out a repetition scheme 511-512 of protocol data units to assure a satisfactory reception of data at the receiver side. Assume Node-B has buffered data to transmit 3 MAC-hs PDUs. Assume further that corresponding sequence numbers are 1, 2, and 3 and Node-B has determined that three repetitions are sufficient for each MAC-hs.

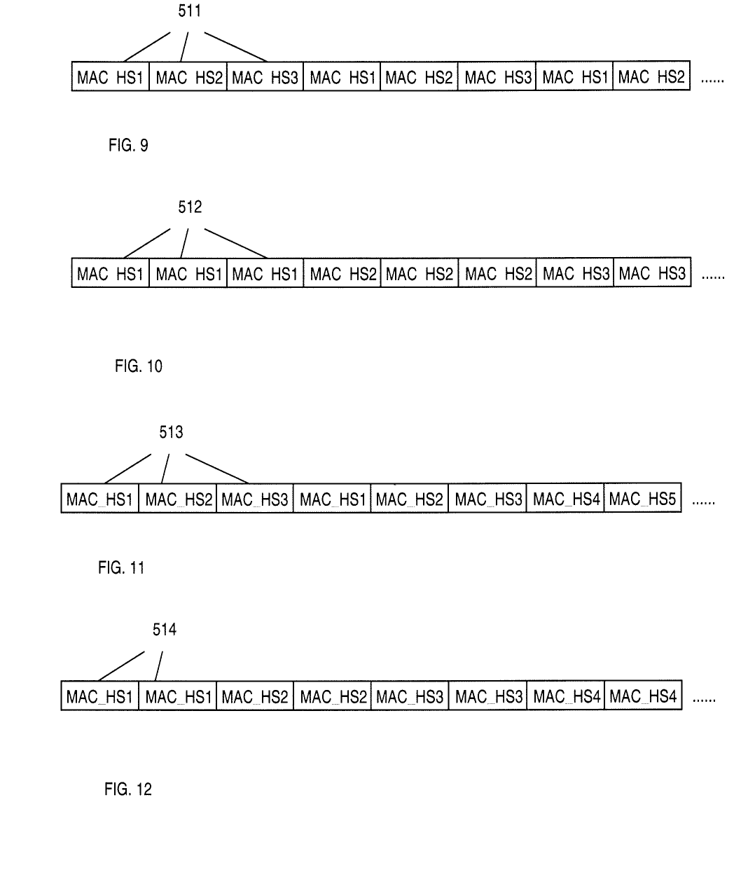

One example of MAC-hs transmissions is shown in FIG. 9, showing the transmitted MAC-hs multicast protocol data units is indicated, whereby the index number corresponds to the MAC-hs sequence number of a given HARQ process.

According to a second variant, the repetition scheme (511, 513; 512, 514) may vary dynamically with estimated channel information (CQI) received from user entities making use of the multicast transmission, such that the number of repetitions depends on the estimated channel quality (403-405).

For instance the repetition schemes of 511 and 512 s modified upon good channel conditions.

For example the repetitions being less frequent in 513 than in 511 of FIGS. 9 and 11. Here, the same media access channel protocol data units (MAC-hs PDU's) are non-consecutively retransmitted a first number of times at a given repetition number (511, 513). Likewise 514 in FIG. 12 is less frequent than 512 of FIG. 10. Here the same media access PDU's (MAC-hs), having the same payload is retransmitted without interruption (512, 514).

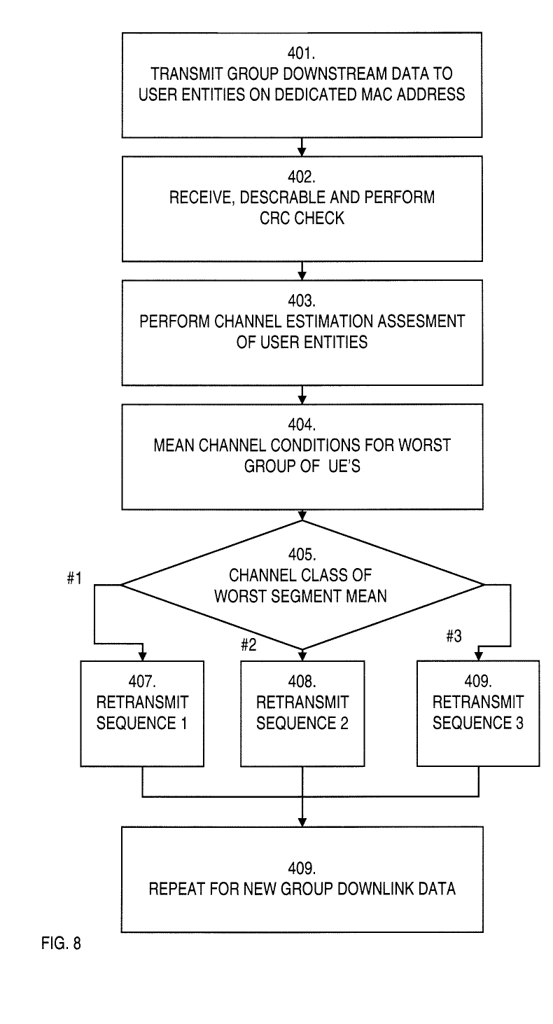

In FIG. 8, according to the second variant, a preferred embodiment of the base station procedure is shown

In step 401, multicast is streamed to user entities on a dedicated multicast MAC address.

In step 402—the base station receives and descrambles feedback messages (ACK, NACK, DTX) from a plurality of user entities listening to the given multicast address (M-ID),

The base station, in step 403—is performing channel estimation assessment of user entities taking part in the multicast transmissions.

For instance, the mean channel conditions for a worst group of assigned multicast user entities are determined, 405, and forms the basis for a repetition scheme shown in FIGS. 9-12.

In steps 407-409—a selecting of a given retransmission scheme for retransmitting MAC protocol data units depending on the channel assessment is made, for instance more retransmissions being performed if the channel conditions are bad, according to steps 407, 408, 409.

Advantageously, according to this embodiment—the base station (Node B) is ignoring transmission feedback messages ACK, NACK, DTX from user entities pertaining to the given multicast address, MU-ID,

To allow Node B to transmit with an arbitrary repetition scheme, the retransmit timer T1 should be set high enough to allow for all repetitions of a sequence number to occur. E.g. when delay is less critical a long T1 retransmit timer can be used to allow arbitrary repetitions scheme, whilst if delay is crucial, a shorter T1 retransmit timer is to be used and Node B must use repetitions with time between first and last repetitions within the T1 retransmit timer range.

In the above embodiment, Node B has a mapping between MU_ID and UD_ID as described in connection with the first embodiment.

A certain range within the current user identity (UE ID) address range that is used for unicast MAC-hs transmissions could be used for multicast/broadcast transmissions.

By using knowledge of the channel quality information from each UE (that is received via the HS-DPCCH) Node-B can determine the repetition scheme as well as the modulation, the transmit power and the MAC-hs PDU size. Node B can also determine when to switch over from broadcast transmission to regular MAC-hs unicast transmission with feedback from each UE. The downside is then of course, that the traffic must be sent to each UE, but it may be favorable based on the current amount of present UE in the cell.

### Embodiment 4

According to a fourth embodiment, the UE does not transmit any HS-DPCCH for multicast/broadcast transmissions. The drawback is of course that Node-B lacks information regarding the downlink channel conditions, but a benefit will occur since the UE will save power. A robust repetition scheme, as in FIG. 9 or 10, 511, 512 is advantageously used permanently for the multicast transmissions.

The user entity may be informed about available channels and the set-up and decoding of multicast and unicast ID's is carried out as explained above.

1. A method for a high speed downlink packet access (HSPDA) base station working in acknowledged mode, the base station being adapted for unicast transmission on a physical downlink shared channel (HS-DSCH), by preceding announcement on a shared control channel (HS-SCCH) which shared control channel may be decoded by a given user entity using its own identity, each user entity being adapted for transmitting an acknowledge (ACK) or non-acknowledge (NACK) message pertaining to the reception of the given transmission on an uplink dedicated physical control channel (HS-DPCCH) pertaining to a given HARQ process of a given individual user entity, wherein the base station performs multicast transmissions on the physical downlink shared channel (HS-DSCH) by preceding announcement on the shared control channel (HS-SCCH) coded with a multicast identity (MU-ID) of a reserved address space, which downlink shared channel (HS-SCCH) may be decoded simultaneously by a plurality of user entities, wherein each respective user entity is using the multicast identity (MU-ID).

2. The method according to claim 1, wherein the base station:
receives and descrambles feedback messages from a plurality of user entities listening to the given multicast address; and
upon receiving at least one not acknowledge message,
retransmits the at least one HSPDA downlink multicast protocol data units, unless re-transmissions have been attempted above an upper limit or upper time limit.

3. The method according to claim 1, wherein if at least one non-acknowledge message (NACK) has been received, and retransmissions have been attempted a number of times corresponding to an upper limit or for an upper time limit,
discarding data in the multicast HARQ transmitter entity.

4. The method according to claim 1, further comprising the steps of:
receiving and descrambling feedback messages from a plurality of user entities listening to the given multicast address;
performing channel estimation assessment of user entities taking part in the multicast transmissions; and,
selecting a given retransmission scheme for retransmitting MAC protocol data units depending on the channel assessment, more retransmissions being performed if the channel conditions are bad.

5. The method according to claim 4, wherein the mean channel conditions for a worst group of assigned multicast user entities are determined and forms the basis for a repetition scheme.

6. The method according to claim 1, wherein the base station is ignoring transmission feedback messages from user entities pertaining to the given multicast address,
the base station performing a repetition scheme of protocol data units pertaining to the multicast transmission, such that the same media access PDU's, having the same payload are retransmitted a first given number of times according to a repetition scheme.

7. The method according to claim 5, wherein the repetition scheme varies dynamically with estimated channel information received from user entities making use of the multicast transmission, such that the number of repetitions depends on the estimated channel quality.

8. The method according to claim 5, wherein the same media access PDU's, having the same payload retransmitted without interruption.

9. The method according to claim 5, wherein the same media access channel protocol data units are non-consecutively retransmitted a first number of times at a given repetition number.

10. A method for a user entity working in acknowledged mode, the user entity being adapted for receiving unicast transmission on
a physical downlink shared channel, by preceding announcement on a shared control channel which shared control channel may be decoded by the user entity, using its own identity, the user entity being adapted for transmitting an acknowledge or non-acknowledge message pertaining to the reception of the given transmission on an uplink dedicated physical control channel pertaining to a given HARQ process of a given individual user entity, wherein the user entity is
receiving multicast transmissions on the physical downlink shared channel by preceding announcement on the shared control channel coded with a multicast identity of a reserved address space, which downlink shared channel may be decoded simultaneously by a plurality of user entities, wherein each user entity is using the multicast identity instead of the user entity's respective user identity,

11. The method according to claim 10, moreover comprising the steps of
testing whether a shared control channel is successfully decoded with the given user entity identity,
testing whether the shared control channel is successfully decoded with a multicast identity,
if the shared control channel is successfully decoded with at least a multicast or a user entity identity and
if a given HARQ process is successfully decoded,
generating an acknowledge message, and if not, generating a not acknowledge message.

12. The method according to claim 11, wherein, before decoding the HARQ process, if a flush indicator is being detected, flushing the corresponding HARQ process.

13. The method according to claim 11, wherein when an acknowledge signal is generated and the shared control channel was successfully decoded with given user entity identity, delivering the MAC-hs protocol data unit to a user identity reordering entity in the user entity, based on a given queue identity.

14. The method according to claim 11, wherein when an acknowledge signal is generated and the shared control channel was successfully de-coded with given multicast identity, delivering the MAC-hs protocol data unit to a multicast identity reordering entity in the user entity, based on a given queue identity.

15. The method for a user entity according to claim 10, wherein
the method comprising the steps of
browsing the web and activating a multicast user entity identity,
receiving a pre-configuration comprising a list of multicast identities corresponding to respective channels of various content,
selecting a given multicast identity and subsequently using the selected multicast identity in decoding of the downlink shared control channel.

16. The method according to claim 1, wherein the base station is
receiving and descrambling feedback messages from a plurality of user entities listening to the given multicast address,
whereby upon receiving at least one not acknowledge message or upon receiving at least one discontinuous transmission message,
retransmitting, the at least one HSPDA downlink multicast protocol data units, unless re-transmissions have been attempted above an upper limit or upper time limit.

17. A base station comprising a MAC-hs control message handler, a scheduler, a number of input buffers storing segments of data streams pertaining to individual user entities corresponding to a number of HARQ processes for handling simultaneous transmissions to several UE's, Layer 1 processing means for transferring data from respective HARQ processes, the base station moreover comprises a channel quality indicator decoder, a user entity feedback decoder and a layer-1 receiver,
the base station moreover comprises at least one specific input buffer queue dedicated to multicast content and a corresponding set of HARQ processes in a multicast HARQ entity dedicated to the multicast content.

18. A user entity arrangement comprising HS-SCCH decoding means, for decoding the downlink HD-PDSCH channel, the user entity arrangement comprising of a first number HARQ processes, a second number of reordering and disassembly queues, a RLC layer means, a User Entity feedback processing means and layer-1 processing for providing feed-back on the HS-DPCCH channel, whereby
the user entity moreover comprises at least one dedicated HS-SSCH multicast channel decoder and a corresponding set of HARQ process entities
mirroring the multicast content HARQ processes of a base station.
